(19) United States
(12) Patent Application Publication
(10) Pub. No.: US 2026/0063128 A1
(43) Pub. Date: Mar. 5, 2026

(54) Water Pump

(71) Applicant: COAVIS, Yeonseo-myeon (KR)

(72) Inventors: Hyuntae Lee, Sejong-si (KR); Seongjin Son, Ulju-gun (KR); Sungwoong Park, Cheonan-si (KR)

(21) Appl. No.: 19/310,989

(22) Filed: Aug. 27, 2025

(30) Foreign Application Priority Data
Aug. 28, 2024 (KR) 10-2024-0115529

(51) Int. Cl. F04D 13/06; F04D 29/043; F04D 29/22; F04D 29/58

(52) U.S. Cl. CPC F04D 13/0606; F04D 29/043; F04D 29/22; F04D 29/5806; F05D 2210/11

(57) ABSTRACT

Provided is a water pump capable of pumping coolant by rotating an impeller, and more particularly, to a water pump that solves a problem caused by an impeller being lifted due to a pressure difference generated during pumping.

### CROSS-REFERENCE TO RELATED APPLICATIONS

This application claims priority to Korean Patent Application No. 10-2024-0115529 filed Aug. 28, 2024, the disclosure of which is hereby incorporated by reference in its entirety.

### BACKGROUND

### Technical Field

The following disclosure relates to a water pump capable of pumping coolant by rotating an impeller, and more particularly, to a water pump that solves a problem caused by an impeller being lifted due to a pressure difference generated during pumping.

### Technical Considerations

A water pump is a device for circulating a coolant to an engine or heater for cooling the engine or heating a room. The water pumps are broadly categorized into a mechanical water pump and an electric water pump. The mechanical water pump is a pump that is connected to an engine crankshaft and driven by a rotation of a crankshaft, and the electric water pump is a pump that is driven by a rotation of a motor controlled by a control device. Recently, due to trends such as increasing control complexity and precision, as well as the growing number of vehicles whose prime mover is not an engine such as hybrid or electric vehicles, the use of electric water pumps has been increasing. Various examples of such electric water pumps are well disclosed in Korean Patent Laid-Open Publication No. 2015-0052436 (“Water Pump”, May 14, 2015).

FIGS. 1 and 2 are assembled and exploded perspective views of the conventional electric water pump. FIG. 3 is a front cross-sectional view of the conventional electric water pump (though slightly different in detailed configuration from the water pumps of FIGS. 1 and 2, the overall configuration and operating principles are approximately the same). As illustrated in FIGS. 1 to 3, the water pump includes a stator 10, a lower casing 20, a motor housing 30, a rotor 40, an impeller 50, and an upper casing 60. The stator 10 electrically provides rotational driving force, the motor housing 30 accommodates and supports the stator 10, and the rotor 40 directly rotates by receiving the rotational driving force while being coupled to the impeller 50 to rotate the impeller 50. The lower casing 20, the impeller 50, and the upper casing 60 are components that directly serve to pump the coolant, and the impeller 50 pumps the coolant by rotating while being accommodated in a portion of the space formed by the coupling of the upper casing 60 and the lower casing 20.

A more specific description of the pumping of the coolant is as follows. A central portion of the upper casing 60 is provided with an inlet 6A extending vertically, and an edge thereof is provided with an outlet 6B extending tangentially. The coolant flowing into the central portion through the inlet 6A is driven toward the edge by the rotating the impeller 50. In this case, the coolant is accelerated by the centrifugal force generated by the rotational force of the impeller 50. Through this process, the coolant collected at the edge of the impeller 50 is discharged to the outside through the outlet 6B extending tangentially to a point on the circumference of the edge of the impeller 50.

Meanwhile, as described above, the impeller 50 is coupled to the rotor 40, and the rotor 40 rotates by the stator 10, thereby rotating the impeller 50. In this case, the lower space in which the rotor 40 is accommodated is in direct communication with the edge of the impeller 50 and the outlet 6B space, so the pressure is formed in the same manner. However, as described above, the coolant introduced into the inlet 6A is pressurized by the impeller 50 and moves toward the edge. That is, the coolant pressure at the edge is formed at a higher pressure compared to the inlet 6A. From the perspective of the impeller 50, an upper space of the impeller 50 is low pressure, and a lower space thereof is high pressure. As a result, upward thrust is inevitably generated during the operation of the impeller 50.

It is well known that the upward thrust reduces the performance and efficiency of the water pump. Furthermore, the friction in a bearing or a support structure that axially supports a rotary shaft of the rotor increases, thereby reducing durability and service life. However, it is impossible to completely prevent such upward thrust from occurring due to the structure and operating principle of the impeller of the water pump. Therefore, various research efforts are being conducted to minimize the negative effects of the upward thrust while maximizing the performance and efficiency of the water pump.

### SUMMARY

A non-limiting embodiment of the present disclosure is directed to a water pump that effectively reduces upward thrust generated when an impeller rotates. More specifically, the present disclosure provides a water pump that reduces pressure by intentionally reducing a coolant flow velocity by forming a labyrinth structure in a lower space of a balance hole, thereby reducing upward thrust and effectively alleviating the surge of an impeller.

In one non-limiting aspect, a water pump includes: an upper casing and a lower casing that are coupled to each other to form an impeller accommodation space therein, and have an inlet formed above a central portion of the impeller accommodation space to communicate with the impeller accommodation space and to allow fluid to flow in, a discharge channel formed radially outside the impeller accommodation space to communicate with the impeller accommodation space, and an outlet connected to the discharge channel to discharge the fluid to an outside; an impeller that is rotatably accommodated in the impeller accommodation space; a rotor that is formed with a rotor accommodation part that protrudes downward from the central portion of the lower casing to form a rotor accommodation space therein, provided in the rotor accommodation part, and coupled to the impeller (500); and when the space within the inlet is referred to as a low-pressure space (L), and the space between the rotor and the rotor accommodation part is referred to as an intermediate-pressure space (M), a balance hole that is formed in a form of a through hole extending vertically on the rotor to allow the low-pressure space and the intermediate-pressure space to communicate with each other, in which a labyrinth structure that is formed on the intermediate-pressure space to suppress fluid flow.

When the space within the discharge channel is referred to as a high-pressure space, coolant introduced into and discharged from the water pump may form a coolant flow that includes a first path in which the coolant introduced into the inlet is pressurized by a rotation of the impeller and flows into the high-pressure space, a second path in which a portion of the coolant collected in the high-pressure space flows into the intermediate-pressure space through a space between an outer side surface of the rotor and an inner side surface of the rotor accommodation part, and a third path in which a portion of the coolant collected in the intermediate-pressure space returns to the low-pressure space through the balance hole.

The labyrinth structure may be formed on the path through which a portion of the coolant introduced from the high-pressure space into the intermediate-pressure space (M) flows in the balance hole.

The labyrinth structure may be a baffle extending vertically to selectively restrict the fluid flow from an outer circumference toward a center of the rotor in the radial direction.

The baffle may be formed in a cylindrical shape having the same center as a center of a rotary shaft of the rotor and the impeller, and may be formed to protrude from a floor upper surface of the rotor accommodation part or a floor lower surface of the rotor.

The baffle may be formed as a single unit or arranged in plurality to form concentric circles.

Each of the baffles may protrude from the floor upper surface of the rotor accommodation part and have an upper side partially open to form a flow path, or protrude from a floor lower surface of the rotor and have a lower side partially open to form a flow path, and when the baffle is formed in plurality, sides of each baffle that is open to form the flow path may be formed to be the same as or different from each other.

The baffle may be formed as a separate component from and coupled to the rotor accommodation part or the rotor, or may be formed integrally therewith.

The impeller may be a centrifugal type.

The water pump may further include: a motor housing that is formed in a shape of a concave container with an open upper side and coupled to the lower casing; and a stator that is provided inside the motor housing and has a rotor accommodation part of the lower casing inserted into and coupled to the central portion thereof.

### BRIEF DESCRIPTION OF THE DRAWINGS

FIG. 1 is an assembled perspective view of a conventional water pump;

FIG. 2 is an exploded perspective view of the conventional water pump;

FIG. 3 is a front cross-sectional view of the conventional water pump;

FIG. 4 is a front cross-sectional view of a water pump of the present disclosure;

FIG. 5 is a front cross-sectional view of the water pump and a top view of a baffle of the present disclosure;

FIG. 6 is a diagram illustrating a coolant flow in the front cross-sectional view of the water pump of the present disclosure;

FIG. 7 is a diagram illustrating embodiments of the baffle of the water pump of the present disclosure;

FIG. 8 is a CFD analysis result comparing pressure between the related art and the present disclosure; and FIG. 9 is a CFD analysis result comparing flow velocity between the related art and the present disclosure.

### DETAILED DESCRIPTION

Hereinafter, a water pump according to a non-limiting embodiment of the present disclosure having a configuration as described above will be described in detail with reference to the accompanying drawings.

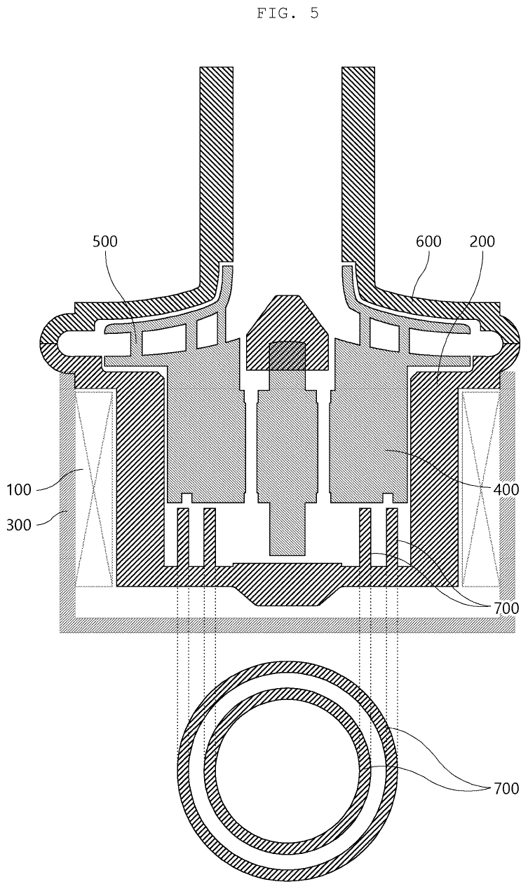

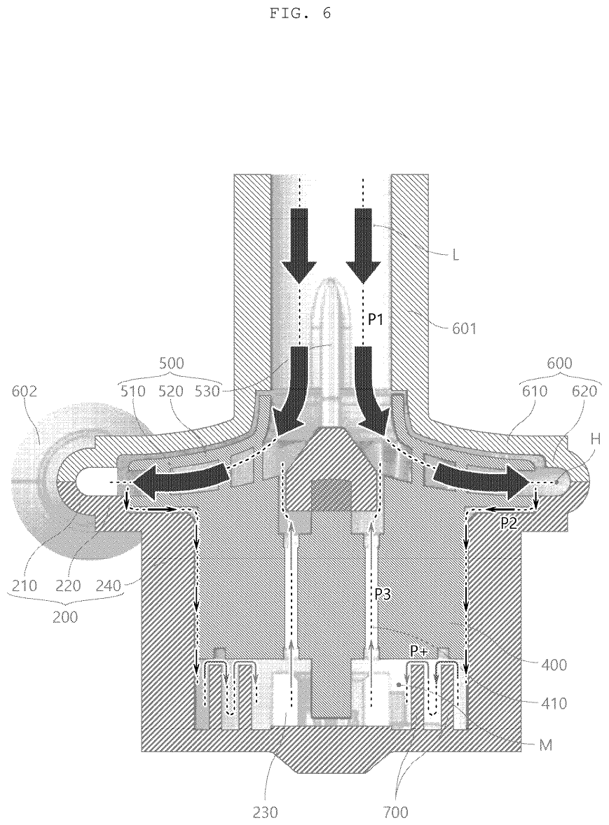

FIG. 4 is a front cross-sectional view of a water pump of the present disclosure, and FIG. 5 more simply illustrates the front cross-sectional view of FIG. 4 while additionally illustrating a top view of the baffle. In addition, FIG. 6 illustrates in detail a coolant flow in the front cross-sectional view of FIG. 4.

Referring to FIG. 4, the water pump of the present disclosure basically includes an upper casing 600 and a lower casing 200 that are coupled together to form an impeller accommodation space therein, and an impeller 500 rotatably accommodated in the impeller accommodation space. As illustrated in FIG. 4, in an assembly structure formed by assembling the upper casing 600 and the lower casing 200, an upper side of a central portion of the impeller accommodation space is formed with an inlet 601 communicating with the impeller accommodation space to allow fluid to flow in. In addition, an outer side of the impeller accommodation space is radially formed with a discharge channel communicating with the impeller accommodation space and an outlet 602 connected to the discharge channel to discharge fluid to the outside. In addition, similar to the conventional water pump, in order to form the impeller accommodation space, the upper casing 600 is formed with an upper seating part 610 and the lower casing 200 is formed with a lower seating part 210. In addition, in order to form the discharge channel, the upper casing 600 is formed with an upper flow path part 620 and the lower casing 200 is formed with a lower flow path part 220.

The upper casing 600, the lower casing 200, and the impeller 500 are components that directly pump coolant. Referring to FIG. 5, the water pump of the present disclosure may further include a rotor 400, a motor housing 300, and a stator 100, which are components that electrically apply a rotational force to rotate the impeller 500. Referring to FIGS. 4 and 5, a central portion of the lower casing 200 is formed with a rotor accommodation part 240 that protrudes downwardly to form a rotor accommodation space therein, and the rotor 400 is provided in the rotor accommodation part 240 and formed to be coupled to the impeller 500. The assembly of the impeller 500 and the rotor 400 rotates around a rotary shaft 530, and a center of a floor upper surface of the rotor accommodation part 240 may be provided with a rotary shaft bearing 230 to prevent the rotary shaft 530 from being displaced.

In addition, the motor housing 300 is formed in the shape of a concave container whose upper side is open and is coupled to the lower casing 200, the stator 100 is provided inside the motor housing 300, and the rotor accommodation part of the lower casing 200 is inserted and coupled to the central portion.

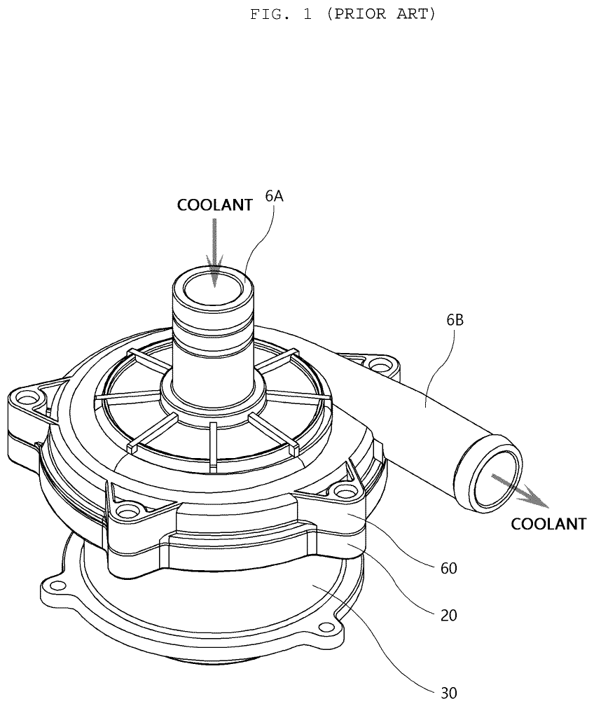

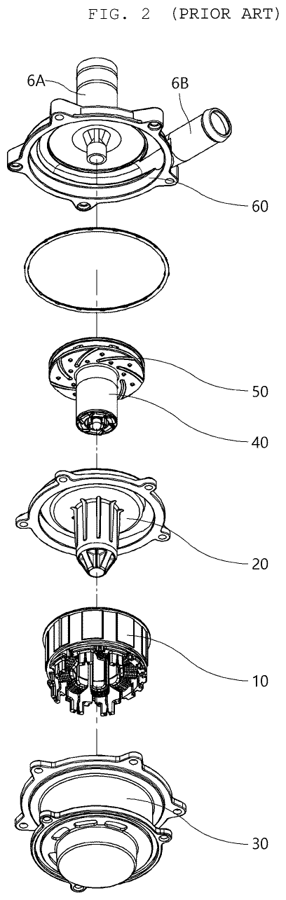

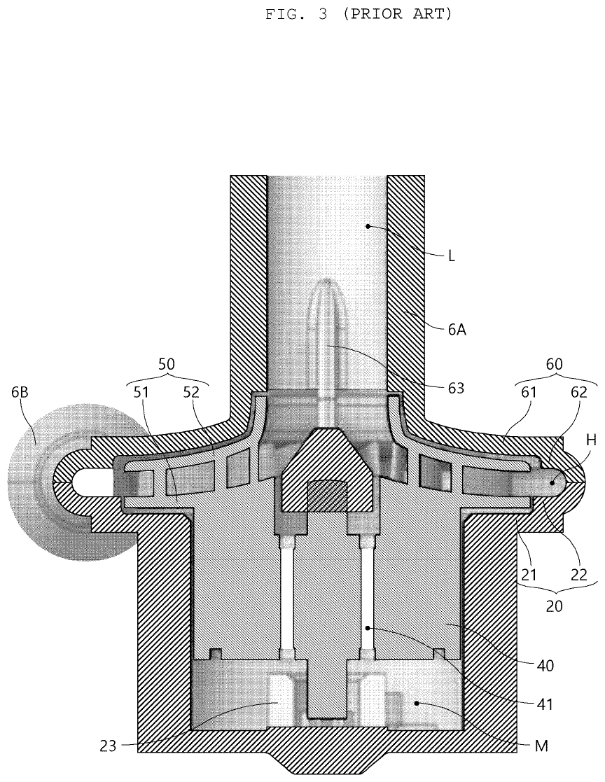

Similar to the conventional water pump illustrated in FIGS. 1 to 3, the water pump of the present disclosure is also a centrifugal type, and is configured to rotate and pressurize coolant introduced through the inlet 601 formed in the central portion of the impeller 500, collect the coolant into the discharge channel formed at an edge of the impeller 500 in a radial direction, and ultimately discharge the coolant through the outlet 602 that is formed to communicate with the discharge channel. Accordingly, the space within the discharge channel is formed at high pressure and therefore is called a high-pressure space H, and similarly, the space within the inlet 601 is called a low-pressure space L, and the space between the rotor 400 and the rotor accommodation part 240 is called an intermediate-pressure space M. As a result, only the low-pressure space L exists on the upper side of the impeller 500, and the high-pressure space H or the intermediate-pressure space M exists on the lower side of the impeller 500. Therefore, when the impeller 500 operates, the impeller inevitably receives an upward thrust and rises.

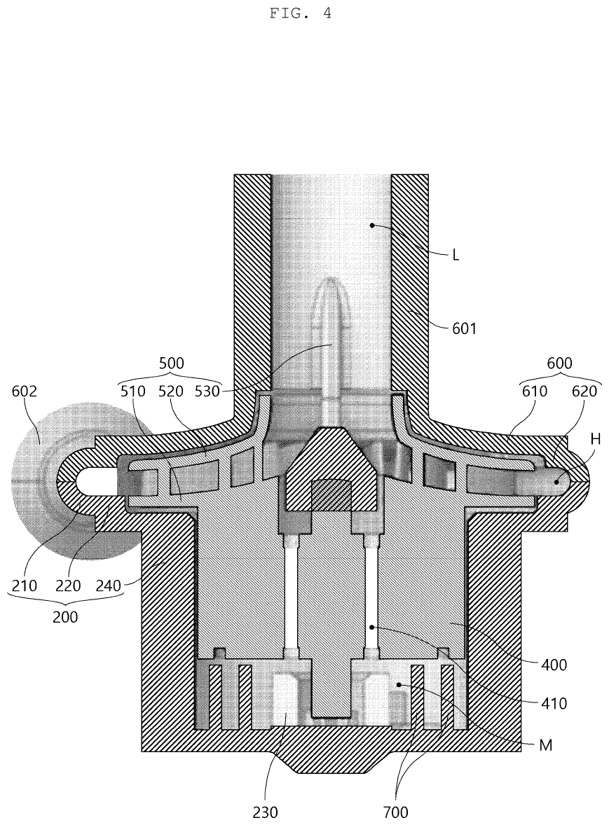

A balance hole 410 has been applied as one of the configurations to solve this problem in the past (indicated by reference numeral 41 in FIG. 3, which is a drawing of the related art). The balance hole 410 is formed in the form of a through hole extending vertically on the rotor 400 and serves to allow the low-pressure space L and the intermediate-pressure space M to communicate with each other. In reality, the intermediate-pressure space M is a space between the floor upper surface of the rotor accommodation part 240 and the floor lower surface of the rotor 400, and is directly connected to the high-pressure space H, and as a result, ideally, a high pressure equivalent to that of the high-pressure space H may be formed. However, in reality, only a portion of the coolant from the high-pressure space H flows into this space. In this process, a pressure slightly lower than that of the high-pressure space H is usually formed due to effects such as a drop in flow velocity due to frictional resistance, etc. In this case, when the balance hole 410 is formed so that the low-pressure space L and the intermediate-pressure space M communicate with each other, the pressure of the intermediate-pressure space M becomes lower than when the balance hole 410 is not present. That is, the upward thrust that causes the impeller 500 to rise is weakened, so the impeller rising problem may be solved to some extent simply by forming the balance hole 410.

In addition, according to the present disclosure, by forming the labyrinth structure that suppresses fluid flow in the intermediate-pressure space M, the pressure of the intermediate-pressure space M is further lowered. In other words, the upward thrust acting on the impeller 500 is further weakened.

Referring to FIG. 6, the coolant flow in the water pump of the present disclosure will be described in more detail as follows. As illustrated in FIG. 6, the coolant introduced into and discharged from the water pump is generally collected in the high-pressure space H, i.e., the discharge channel, through a first path P1 in which the coolant introduced into the inlet 601 is pressurized by the rotation of the impeller 500 and flows into the high-pressure space H. The collected coolant flows in the circumferential direction of the impeller 500 along the discharge channel, and then meets the outlet 602 and is discharged to the outside. Meanwhile, a portion of the coolant passes through the first path P1, and then sequentially circulates through the second path P2 and the third path P3. Describing in detail the path, first, the second path P2 is a path through which a portion of the coolant collected in the high-pressure space H flows into the intermediate-pressure space M through a space between an outer side surface of the rotor 400 and an inner side surface of the rotor accommodation part 240. In addition, the third path P3 is a path through which a portion of the coolant collected in the intermediate-pressure space M returns to the low-pressure space L through the balance hole 410.

According to the present disclosure, the labyrinth structure is formed on the path through which a portion of the coolant introduced from the high-pressure space H into the intermediate-pressure space M flows in the balance hole 410. FIG. 6 illustrates that the labyrinth structure is a baffle 700 extending vertically to selectively restrict the fluid flow from an outer circumference toward a center of the rotor (400) in the radial direction. As in the related art of FIG. 3, when there is no labyrinth structure of the present disclosure, the coolant that has flowed into the intermediate-pressure space M through the second path P2 will return to the low-pressure space L through the third path P3 without any particular resistance. However, in the present disclosure, since the labyrinth structure is formed, the coolant that has flowed into the intermediate-pressure space M through the second path P2 should pass through a complex additional path P+ illustrated in FIG. 6 to enter the third path P3. When the fluid passes through the additional path P+having such a complex shape, the flow velocity naturally decreases due to the flow path resistance. The decrease in the flow velocity means a decrease in pressure, and therefore, the pressure in the intermediate-pressure space M is formed at a lower pressure compared to when the labyrinth structure is not present. Accordingly, the upward thrust of the impeller 500 may be further reduced compared to the conventional method.

To elaborate, as the diameter of the balance hole 410 decreases, the pressure in the intermediate-pressure space M approaches the pressure in the high-pressure space H. Conversely, as the diameter of the balance hole 410 increases, the pressure in the intermediate-pressure space M approaches the pressure in the low-pressure space L. From the perspective of solving the impeller rising problem alone, increasing the diameter of the balance hole 410 will yield better results. However, the increase in the amount of coolant circulating through the low-pressure space L—intermediate-pressure space M—high-pressure space H means, in other words, that the amount of coolant that entered the inlet 601 and discharged through the outlet 602 decreases. This lowers the efficiency of the water pump itself, and, in other words, the problem of reduced efficiency due to coolant leakage occurs, which is different from the problem of reduced efficiency due to the rise of the impeller. This is because the coolant circulated through the balance hole 410 is, in fact, a leakage from the perspective of water pump operation.

Due to this problem, there was a limit to lowering the pressure of the intermediate-pressure space M using the balance hole 410. However, according to the present disclosure, by forming the labyrinth structure such as the baffle 700 in the intermediate-pressure space M, it is possible to very effectively lower the pressure of the intermediate-pressure space M without changing the diameter of the balance hole 410. In addition, since the shape of the labyrinth structure itself is not very complicated (which will be described in more detail through the description of the non-limiting embodiments of the baffle later), a sufficient effect may be obtained simply by providing an additional structure with little change to the configuration of the existing water pump. In particular, the baffle 700 may be formed as a separate component from and coupled to the rotor accommodation part 240 or the rotor 400, or may be formed integrally therewith. Accordingly, the existing production line may be utilized almost as it is, and thus, has very high compatibility in terms of production. In addition, the production line may be optionally selected by a user, considering ease of implementation, cost-effectiveness, etc., between adding an assembly process (when formed as a separate component) or replacing a component mold (when formed as an integral component).

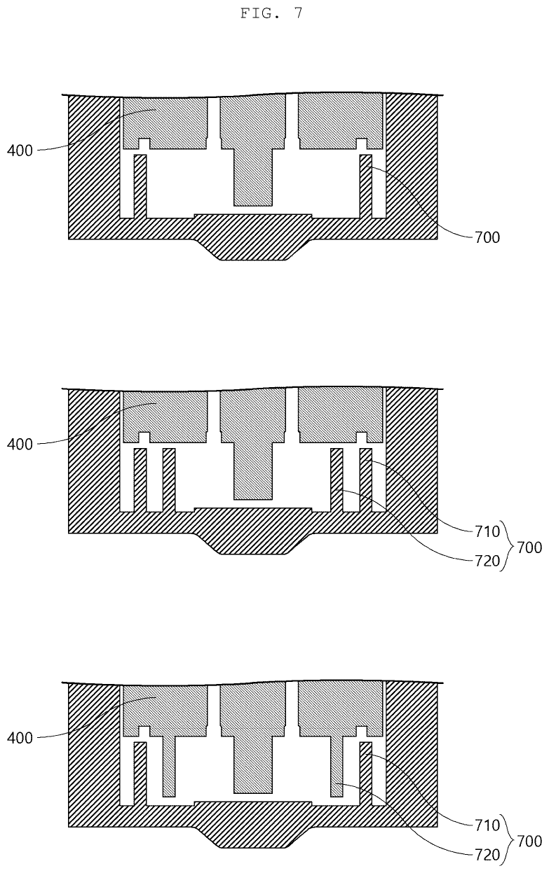

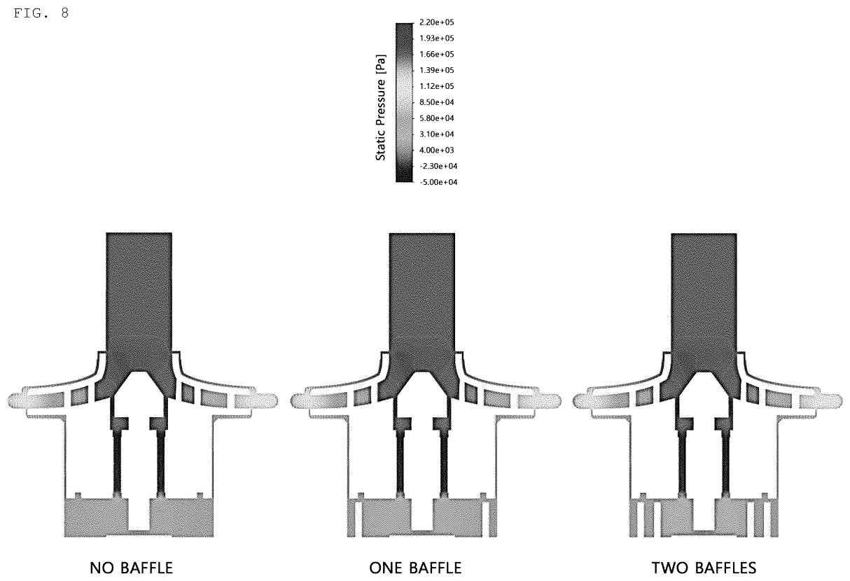

Hereinafter, various non-limiting embodiments of the labyrinth structure will be described with reference to FIG. 7. As described above, the labyrinth structure may be formed of the baffle 700 extending vertically to selectively restrict the fluid flow from the outer circumference toward the center of the rotor 400 in the radial direction. As illustrated in FIGS. 4 and 5, the baffle 700 may be formed in a cylindrical shape having the same center as a center of the rotary shaft 530 of the rotor 400 and the impeller 500.

FIG. 7 illustrates examples in which the baffle 700 protrudes from the floor upper surface of the rotor accommodation part 240 or the floor lower surface of the rotor 400. In particular, in this case, the baffle 700 may be formed as a single one as in the upper side drawing of FIG. 7, or may be arranged as a plurality of ones to form a concentric circle as in the middle or lower drawing of FIG. 7. Describing in more detail, each of the baffles 700 may protrude from the floor upper surface of the rotor accommodation part 240, and have an upper side partially open to form the flow path, or protrude from a floor lower surface of the rotor 400 and have a lower side partially open to form the flow path. The upper side drawing of FIG. 7 illustrates a form in which the single baffle 700 is formed and a part of the upper side of the baffle 700 is open. Meanwhile, when the plurality of baffles 700 are formed as in the middle or lower drawing of FIG. 7, the sides of each baffle 700 that are open to form the flow path may be formed to be the same or different from each other. In both the middle and lower drawings of FIG. 7, two baffles 700 are formed. For convenience, when the outer side is referred to as a first baffle 710 and the inner side is referred to as a second baffle 720, in the middle drawing of FIG. 7, both the first and second baffles 710 and 720 are formed in a form in which a portion of the upper side is open. On the other hand, in the lower drawing of FIG. 7, the first baffle 710 has a portion of the upper side open, while the second baffle 720 has a portion of the lower side open, so the open sides between the baffles are formed differently. Of course, the present disclosure is not limited to the examples of FIG. 7, and the number of baffles, the opening direction, etc., may be variously changed.

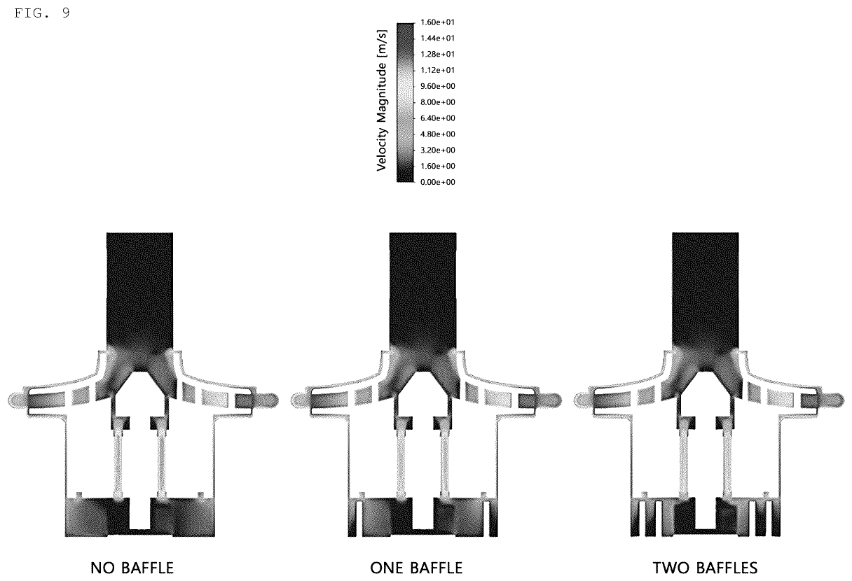

FIGS. 8 and 9 each are CFD analysis results comparing the pressure and flow velocity of the related art and the present disclosure. In both FIGS. 8 and 9, the left side illustrates the results in the case without a baffle, that is, the prior art as in FIG. 3; the middle side illustrates the results in the case with one baffle; and the right side illustrates the results in the case with two baffles. As may be seen from the analysis results, the pressure and the flow velocity are clearly reduced in the case with two baffles compared to the case without the baffle. The calculation results based on the analysis results show that the upward thrust applied to the impeller is reduced by more than 20% by significantly reducing the pressure in the case with two baffles. In addition, as described above, according to the present disclosure, the amount of coolant circulated to the balance hole among the coolant introduced into the water pump (=reducing the discharge amount, which effectively corresponds to the leakage amount) is not changed. In this state, when the upward tendency of the impeller is reduced, it may be expected that the problem of reduced efficiency of the water pump caused by the rising of the impeller will also be naturally improved. In fact, as a result of performing the calculations based on the analysis results, it was confirmed that the presence of two baffles not only reduces the upward thrust by more than 20%, but also improves the efficiency of the water pump by more than 5%.

According to the present disclosure, it is possible to effectively reduce the upward thrust generated during the rotation of the impeller. More specifically, by forming the labyrinth structure in the space under the balance hole to intentionally reduce the coolant flow velocity, it is possible to reduce the pressure in the space under the balance hole. Since the upward thrust acting on the impeller is due to the pressure in the lower space being greater than that in the upper space of the impeller, by reducing the pressure in the lower space of the balance hole, i.e., the space under the central portion of the impeller, it is possible to effectively reduce the upward thrust.

In particular, according to the present disclosure, it is possible to achieve sufficient effects by simply adding additional structures with little change to the configuration of the existing water pump. For example, by providing the concentric baffle in the space under the balance hole, it is possible to realize the labyrinth structure. In other words, according to the present disclosure, it is possible to effectively reduce the upward thrust of the water pump while maintaining the high compatibility with the existing production lines.

The present disclosure is not limited to the above-described exemplary embodiments, but may be variously applied. In addition, the present disclosure may be variously modified by those skilled in the art to which the present disclosure pertains without departing from the gist of the present disclosure claimed in the claims.

What is claimed is:

1. A water pump, comprising:
an upper casing and a lower casing that are coupled to each other to form an impeller accommodation space therein, and have an inlet formed above a central portion of the impeller accommodation space to communicate with the impeller accommodation space and to allow fluid to flow in, a discharge channel formed radially outside the impeller accommodation space to communicate with the impeller accommodation space, and an outlet connected to the discharge channel to discharge the fluid to an outside;
an impeller that is rotatably accommodated in the impeller accommodation space;
a rotor that is formed with a rotor accommodation part that protrudes downward from the central portion of the lower casing to form a rotor accommodation space therein, provided in the rotor accommodation part, and coupled to the impeller; and
when the space within the inlet is referred to as a low-pressure space, and the space between the rotor and the rotor accommodation part is referred to as an intermediate-pressure space, a balance hole that is formed in a form of a through hole extending vertically on the rotor to allow the low-pressure space and the intermediate-pressure space to communicate with each other,
wherein a labyrinth structure is formed in the intermediate-pressure space to suppress fluid flow.

2. The water pump of claim 1, wherein, when the space within the discharge channel is referred to as a high-pressure space,
coolant introduced into and discharged from the water pump forms a coolant flow that comprises:
a first path through which the coolant introduced into the inlet is pressurized by a rotation of the impeller and flows into the high-pressure space,
a second path in which a portion of the coolant collected in the high-pressure space flows into the intermediate-pressure space through a space between an outer side surface of the rotor and an inner side surface of the rotor accommodation part, and
a third path in which a portion of the coolant collected in the intermediate-pressure space returns to the low-pressure space through the balance hole.

3. The water pump of claim 2, wherein the labyrinth structure is formed on the path through which a portion of the coolant introduced from the high-pressure space into the intermediate-pressure space flows in the balance hole.

4. The water pump of claim 3, wherein the labyrinth structure is a baffle extending vertically to selectively restrict the fluid flow from an outer circumference toward a center of the rotor in the radial direction.

5. The water pump of claim 4, wherein the baffle is formed in a cylindrical shape having the same center as a center of a rotary shaft of the rotor and the impeller, and
is formed to protrude from a floor upper surface of the rotor accommodation part or a floor lower surface of the rotor.

6. The water pump of claim 5, wherein the baffle is formed as a single unit or arranged in plurality to form concentric circles.

7. The water pump of claim 6, wherein each of the baffles protrudes from the floor upper surface of the rotor accommodation part and has an upper side partially open to form a flow path, or protrudes from a floor lower surface of the rotor and has a lower side partially open to form a flow path, and
when the baffle is formed in plurality, sides of each baffle that is open to form the flow path are formed to be the same as or different from each other.

8. The water pump of claim 5, wherein the baffle is formed as a separate component from and coupled to the rotor accommodation part or the rotor, or is formed integrally therewith.

9. The water pump of claim 1, wherein the impeller is a centrifugal type.

10. The water pump of claim 1, further comprising:
a motor housing that is formed in a shape of a concave container with an open upper side and coupled to the lower casing; and
a stator that is provided inside the motor housing and has a rotor accommodation part of the lower casing inserted into and coupled to the central portion thereof.
